(19) United States
(12) Patent Application Publication
(10) Pub. No.: US 2002/0170653 A1
(43) Pub. Date: Nov. 21, 2002

(54) Waterproof, breathable articles of apparel

(76) Inventor: Williams Cole, Duarte, CA (US)

Correspondence Address: James E. Brunton, P. O. Box 2900, Suite 860, 700 North Brand Blvd., Glendale, CA, 91209, US

(21) Appl. No.: 10/194,166

(22) Filed: Jul. 12, 2002

Related U.S. Application Data
(63) Continuation-in-part of application No. 09/978,441, filed on Oct. 15, 2001.
Application No. 09/978,441 is a continuation-in-part of application No. 09/384,938, filed on Aug. 27, 1999, now abandoned.

(51) Int. Cl. B65C 3/26

(52) U.S. Cl. 156/156; 156/229; 156/161

(57) ABSTRACT

Articles of apparel and the method of making the same which include a shaped body portion that will allow water vapor due to perspiration to transpire through the article but will prevent water from external sources from reaching the wearer's extremities. The articles of apparel include a body portion that is of three-ply construction with the inside and outside plies being stretch and return and constructed from a meeting yam having a stretchable components and the intermediate ply being made from an elastomeric polyurethane film. The three plies are uniquely bonded together using a specially formulated, waterproof powdered adhesive having a particle size of between about 200 and about 300 microns. The adhesive is melted at a closely controlled temperature to securely bond together the stretch and return fabric components and the elastomeric polyurethane film components to form a finished article.

### SPECIFICATION

This is a Continuation-In-Part application of co-pending application Ser. No. 09/978,441 filed Oct. 15, 2001 which is a Continuation-In-Part application of co-pending application Ser. No. 09/384,938 filed Aug. 27, 1999.

### BACKGROUND OF THE INVENTION

1. Field of the Invention

The present invention relates generally to articles of apparel. More particularly, the invention concerns improved articles of apparel used to cover the wearer's extremities such as an improved, waterproof sock that includes a novel sealing cuff and a body portion that will permit perspiration to transpire through the sock, but will keep water from external sources away from the wearer's foot.

2. Discussion of the Prior Art

Various attempts have been made in the past to produce breathable, waterproof articles of apparel such as gloves and socks that will keep the wearer's hands and feet dry and at the same time permit perspiration to transpire through the article. Materials, which will accomplish this desired function, have been known for sometime. Among the most successful waterproof, breathable articles of apparel ever developed are those developed by the present inventor and described in U.S. Pat. Nos. 5,655,226 and 5,483,703. Because of the pertinence of these patents to a complete understanding of the present inventions, U.S. Pat. Nos. 5,655,226 and 5,483,703 are incorporated by reference as though fully set forth herein.

The present invention constitutes an improvement in the articles described in the aforementioned patents. More particularly, the articles of apparel of the present invention include a novel sealing cuff arrangement that guards against water entering the interior of the article at a location between the cuff and the covered extremity.

As will be better appreciated from the discussion which follows, the present invention provides, for the first time, articles of clothing such as socks and gloves which exhibit the comfort and stretchability of traditional types of sport socks and gloves that include a waterproof body portion and a novel, sealable cuff that provides an article that is both breathable and completely waterproof.

### SUMMARY OF THE INVENTION

It is an object of the present invention to provide comfortable articles of apparel and the method of making the same which include a sealable cuff portion and a shaped body portion that will allow water vapor due to perspiration to transpire through the article but will prevent water from external sources from reaching the wearer's extremities.

A particular object of the invention is to provide a footwear article of the aforementioned character which includes an elastic sealing cuff that seals against the user's leg and prevents the entry of water between the cuff and the user's leg.

Another object of the invention is to provide articles of the aforementioned character in which water vapor from perspiration can be transmitted from the inside to outside of the body portion so that the natural evaporative cooling effect can be achieved.

Another object of the invention is to provide a method of making articles of the character described in the preceding paragraphs which is simple and straight forward, does not require the use of complicated equipment and can be performed by unskilled workmen with a minimum of training.

A particular object of the invention is to provide a sock as described in the preceding paragraphs which is of simple construction, is lightweight, is pliant and durable in use, and is easy to manufacture.

In one form of the invention, the footwear article comprises a sock having a sealable cuff portion and an interconnected body portion. The body portion is of three-ply construction with the inside and outside plies being formed from a knit made up of both elastic and non-elastic fibers and the intermediate ply being made from an elastomeric polyurethane film. The three plies are uniquely bonded together using a pliant, waterproof adhesive. The sealable cuff portion is of a two-ply construction with the outside ply being an elastic knit and the inside ply being a continuation of the elastomeric polyurethane film of the body portion.

### BRIEF DESCRIPTION OF THE DRAWINGS

FIG. 1 is a side-elevational view illustrating the method of making the footwear article of the invention and showing the components of the article in position over a foot-shaped planar mandrel.

FIG. 2 is an enlarged, cross-sectional view taken along lines 2-2 of FIG. 1 showing the two-ply cuff construction.

FIG. 3 is an enlarged, cross-sectional view taken along lines 3-3 of FIG. 1 showing the three-ply construction of the body portion.

FIG. 4 is an enlarged, cross-sectional view taken along lines 4-4 of FIG. 1.

FIG. 5 is an enlarged, fragmentary, cross-sectional, illustrative view showing the manner in which the sealable cuff portion of the sock sealably engages the user's leg.

FIG. 6 is a generally perspective view of one form of the footwear article of the invention shown covering the foot and lower leg portion of the user.

FIG. 7 is an enlarged, cross-sectional view taken along lines 7-7 of FIG. 6.

FIG. 8 is a generally perspective view similar to FIG. 6 but showing the cuff portion of the footwear article folded down.

FIG. 9 is an enlarged, cross-sectional view taken along lines 9-9 of FIG. 8.

FIG. 10 is a side-elevational view illustrating an alternate method of making the footwear article of the invention using a special knitting yarn having a stretchable yarn component and showing the components of the article in position over a foot-shaped planar mandrel.

FIG. 11 is an enlarged, cross-sectional view taken along lines 11-11 of FIG. 10 in.

### DESCRIPTION OF THE INVENTION

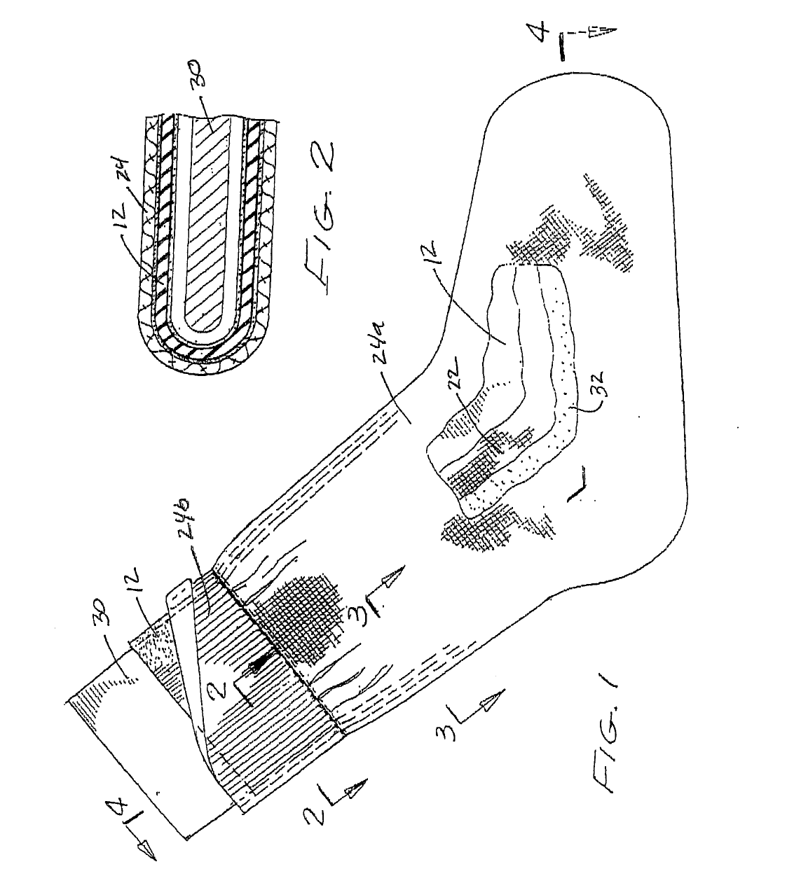

Referring to the drawings and particularly to FIGS. 1 through 4, one form of the article of apparel of the present invention is there shown. The article here comprises a sock construction including a thin, pliant bladder 12 constructed from a waterproof, breathable material, such as polyurethane sheet. The polyurethane sheet can be of various thicknesses as, for example, between about 1.0 mils and about 3.0 mils. Bladder 12 is of a first size and length and includes a lower body portion 14 and an upper cuff portion 16 (FIG. 4). Bladder 12 includes an outer surface 18 and an inner surface 20. Bladder 12 has the unique capability of generally conforming to the contours of the human foot and leg so that it can be comfortably worn inside a boot or shoe.

Bonded to the inner surface 20 of the elastomeric bladder is a lightweight covering member such as a first fabric inner sock 22 of standard construction, which is preferably made from knitted natural or synthetic fibers. Sock 22 is of a second size smaller than said first size and a second length less than the first length of bladder 12 (FIG. 4).

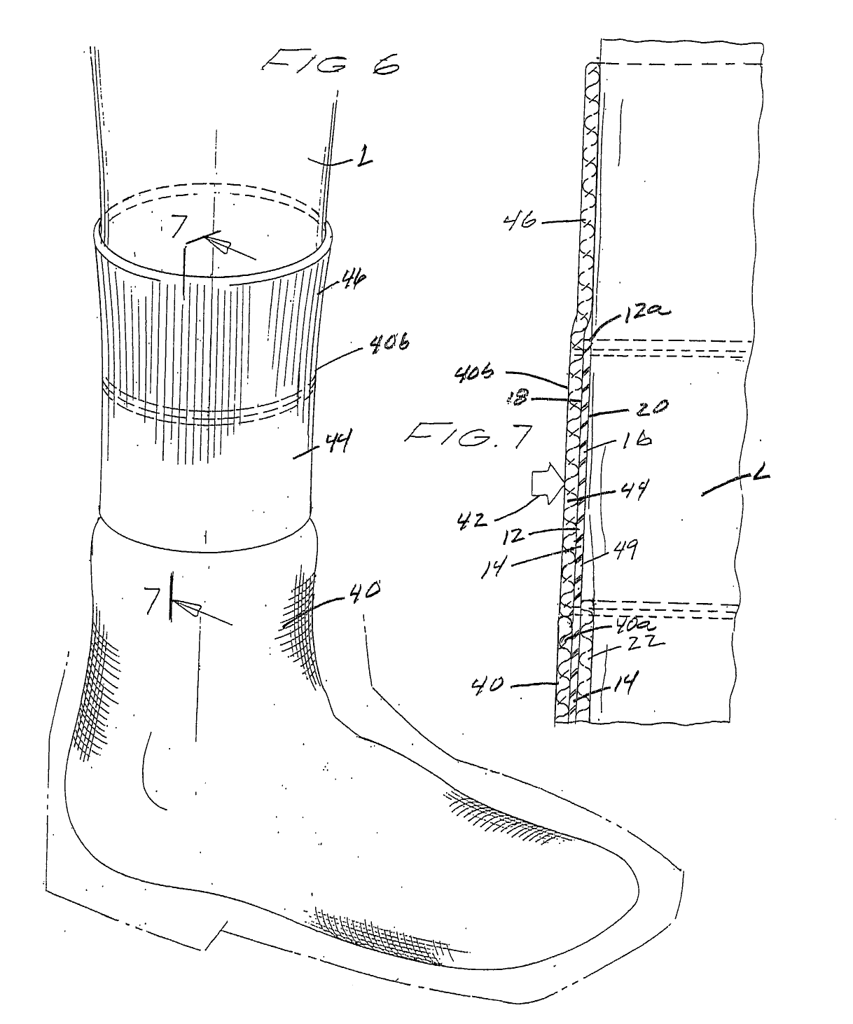

The article of the invention also includes a second fabric outer sock 24, the body portion 24a of which is bonded to the outer surface of the body portion 14 of bladder 12. Body portion 24a can be constructed from filament or spun yarns as well as from natural fibers such as wool fibers, or from a variety of synthetic fibers such as polyester or nylon and combinations thereof. Outer sock 24 also includes an upper cuff portion 24b that embodies elastic fibers that impart elasticity to the cuff portion causing it to be continuously urged inwardly toward the covered extremity. The techniques for weaving the stretch and return cuff portion 24b are well understood by those skilled in the art and several elastic fibers such as a fiber sold by duPont under the name and style “LYCRA” spandex can be used in conjunction with other fibers to form the cuff portion. It is to be observed that second, or outer sock 24 is of a third size larger than the first size of bladder 12 and has a third length greater than the second length of inner sock 20 and also greater than the first length of bladder 12. More particularly, as best seen in FIGS. 4 and 5, the cuff portion of outer sock 24 preferably extends beyond the upper edge 12a of bladder 12 by a distance of about one-half inch.

Inner sock 22 and a portion of outer sock 24 are bonded to bladder 12 by means of a waterproof, heat activated adhesive. A hot melt adhesive in powder form sold by EMS-Chemie (North America) Inc., of Sumpter, S.C. under the name GRILTEX 8 has proven satisfactory for this purpose. Other adhesives can, of course, also be used. In any event, the adhesive should be selected and applied in a manner that the breathability of the footwear is not destroyed or substantially reduced.

In the novel article of the present invention, the entire outer surface of the first sock 22 is securely bonded to bladder 12. However, as best seen in FIGS. 4 and 5, the cuff, or upper portion 16 of bladder 12, has its outer surface securely bonded to the upper elastic cuff portion 24b of an outer sock 24. In a manner presently to be described, elastic cuff 24b uniquely functions to urge the inner surface of the bladder into sealing engagement with the user's leg.

The thin, pliant, thermoplastic material from which the waterproof, breathable bladder is made is of a character that will prevent penetration of liquid water while at the same time permitting free passage of moisture vapor such as perspiration. This material can be a polyurethane sometimes described as thermoplastic urethane. A suitable material of this type is sold by The Dow Chemical Company. Other suitable materials include elastomers made from polyesters, copolyesters, polyamides, cellulose derivatives, polyacrylic acid and its holologs, natural or synthetic rubber with hydrophilic impurities, copolyozamides, polyureas, polyelectrolytes, polyphosphates, polyvinylamid, polyvinylalcohol, polyether, and copolymers thereof, polythioether, polythioether-polyether, copolyepichlorohydrin-ether, polysulphosphates, copolyester-ether and derivatives or mixtures thereof and film materials made by W. L. Gore and Associates, called Goretex that incorporate The DuPont Company's Teflon® polytetraflouroethylene.

Considering next the method of the invention, the thin, pliant bladder membrane is first coated with a light coating 27 of the hot melt adhesive to form a precursor, coated membrane. Next, the precursor, coated membrane is heated to a temperature slightly above the softening point of the adhesive, thereby causing the discrete particles of the adhesive which have been randomly deposited onto the bladder to fuse to the surface of the bladder material to form a coated membrane. Reference should be made to incorporate by reference U.S. Pat. No. 5,862,588 for a more detailed description of this adhesive deposition process.

The next step in one form of the method of the invention is the construction of the waterproof, breathable bladder. This is accomplished by overlaying two sheets of the previously described coated membrane and then to define on the membrane a line circumscribing the boundary of the bladder. This done, the sheets of coated membrane are heated along the boundary line to a temperature sufficient to sealably bond the membranes together along the boundary line. This heating-fusion step can be accomplished in several ways well known to those skilled in the art, including the techniques described in the incorporated by reference U.S. Pat. Nos. 5,655,226 and 5,483,703. The heating-fusion step produces a bladder having a perimeter of a first size and length. As indicated in FIGS. 1 and 5, the bladder 12 has an extremity-receiving portion that is in the general shape of the wearer's extremity.

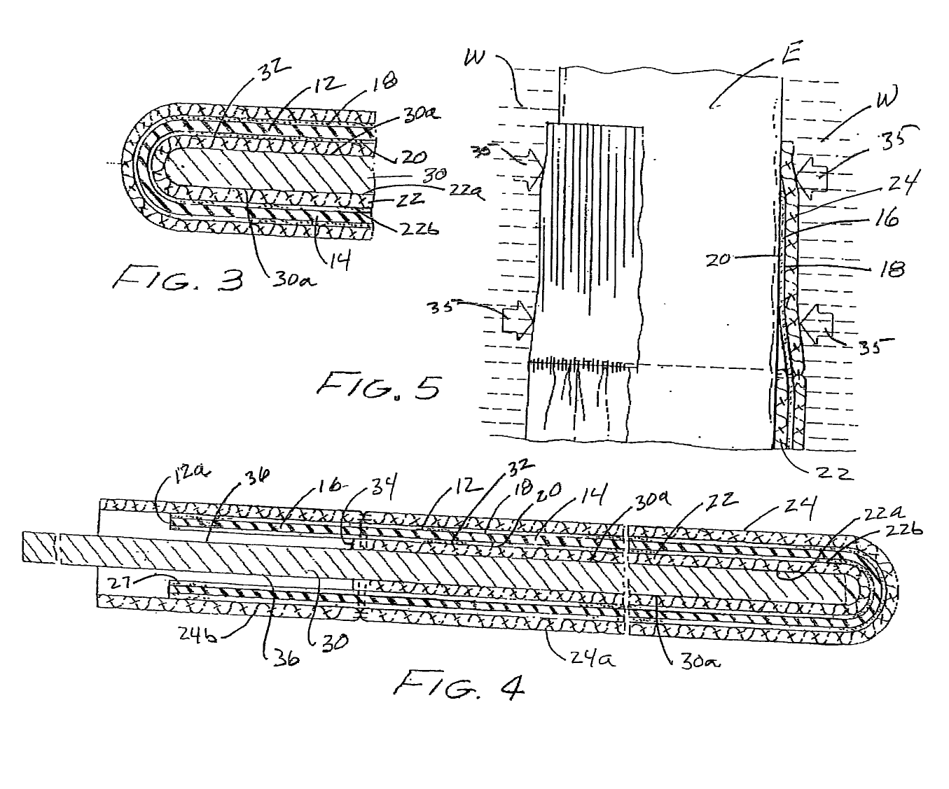

As illustrated in FIGS. 1 and 4 of the drawings, the next step in the method of the invention is to place the first covering member, or inner sock 22 over a generally foot-shaped, approximately 1/16th inch thick, generally planar mandrel 30 having smooth outer surfaces. Sock 22, which has inner and outer surfaces 22a and 22b (FIG. 3) is placed over the mandrel so that inner surface 22a thereof is disposed in engagement with the faces 30a of mandrel 30. As previously discussed, sock 22 can be constructed from a variety of materials and has a perimeter of a second size smaller than the size of the bladder and a second length less than the length of the bladder 12. The inner sock can be made utilizing a COOLMAX® polyester material made by duPont.

After sock 22 has been placed over mandrel 30 and smoothed out so that its inner surface 22a is in close engagement with the faces of the mandrel 30 a first assemblage is formed by carefully placing adhesive coated bladder 12 over the assemblage of sock 22 and mandrel 30 and is smoothed so that the inner surface of the bladder is in close engagement with the sock 22. This first assemblage has a third size and shape as illustrated in the drawings.

After emplacement of the bladder onto the mandrel, a second covering member or sock 24 is emplaced over the bladder which has been previously mounted onto the mandrel and appropriately smoothed out. Second sock 24 has a perimeter of a fourth size larger than the size of the first assemblage and a third length greater than the second length of first sock 22. With this arrangement, the inside of sock 24 is in engagement with the exposed surface 18 of the adhesive coated bladder 12 and the second, or precursor, assemblage thus formed has the configuration shown in FIG. 4. As can be seen in FIG. 4, the lower body portion of the precursor assemblage is three-ply while the upper cuff portion 24b is only two-ply with bladder 12 extending a substantial distance above the upper margin 34 of inner sock 22.

The precursor assembly comprising the bonded together first adhesive coated sock 22, the bladder 12 and the second adhesive coated sock 24 is then heated and compressed in the manner described in the incorporated by reference U.S. Pat. Nos. 5,655,226 and 5,483,703 to form the finished article. Briefly, this step is accomplished by placing the mandrel, upon which the precursor assembly is mounted, between two platens that can be controllably heated and urged together. During this temperature-pressure step, the polymer of the adhesive is bonded and cross-linked making a permanent, waterproof bond of inner sock 22 to outside of the bladder and the outer sock 24 to the other side of the bladder.

Additionally, due to the unique design of the article of apparel of the invention, during the temperature, pressure step, portion 16 of bladder 12, that is the portion of the bladder extending above margin 34 of inner sock 22, is urged against the smooth surfaces 36 of mandrel 30 (FIG. 4). As the adhesive 27, which was previously deposited on bladder 12, melts and is pressed against the mandrel, it will melt to form a smooth surface that exhibits exceptional sealing capabilities.

After completion of the heating and compression step, the precursor assembly is removed from the press and allowed to cool thoroughly prior to doffing the completed waterproof footwear article from the mandrel. When removed from the mandrel, the footwear article is generally planar in shape and in one form of the invention, the article may be stitched along the margin of the bladder and the cuff. In use, when the foot is inserted into the open cuff of the article, the foot-engaging portion of the sock will neatly and smoothly conform to the shape of the wearer's foot.

Similarly, when the sock is in use, the elastic cuff portion 24b of the outer sock 24 exerts inward forces against the user's extremities as indicated by the arrows 35 in FIG. 5. These forces cause the glaze-like surface formed on the bladder to sealably press against the skin of the user forming a substantially water tight seal. As indicated in FIG. 5, even when the user's extremity “E” is submersed in water “W”, this seal will prevent water from passing between the upper bladder portion 16 and the user's skin.

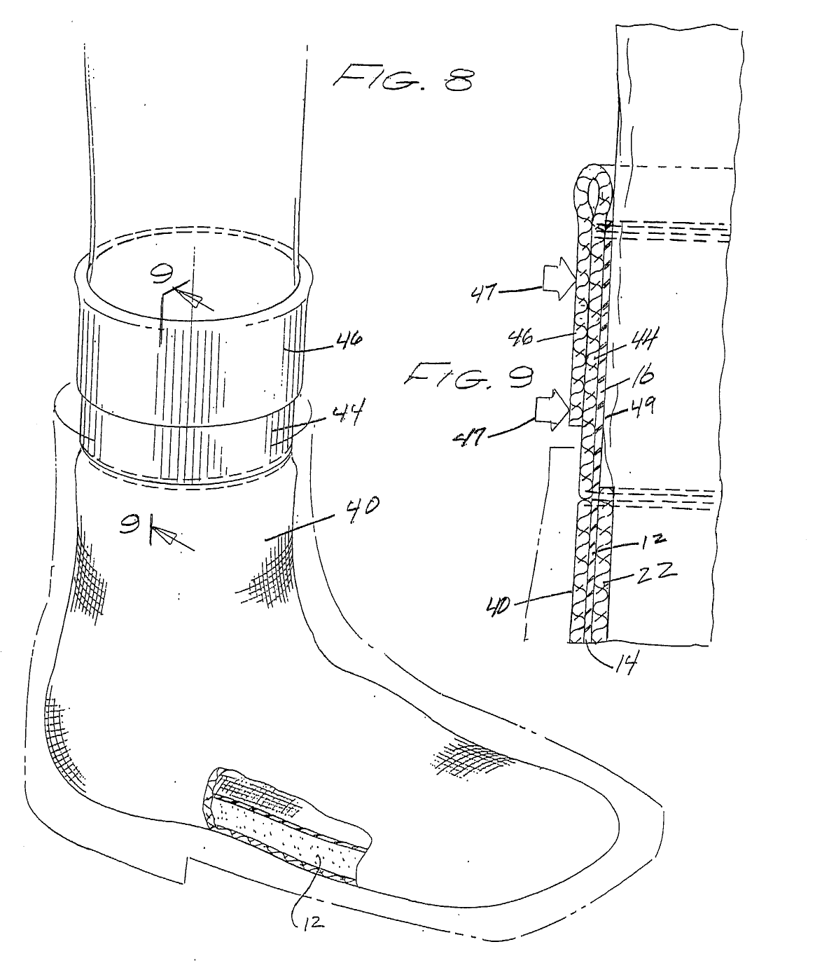

Turning to FIGS. 6 and 7, a slightly different sock construction of the invention is shown in position over a user's foot and lower leg. This sock construction is substantially similar to that shown in FIGS. 1 through 5 of the drawings and like numbers are used to identify like components. As before, the sock construction comprises a thin, pliant bladder 12 constructed from a waterproof, breathable material, such as polyurethane sheet (FIG. 7). Bladder 12 includes a lower body portion 14 and an upper cuff portion 16 and has an outer surface 18 and an inner surface 20. As earlier pointed out, bladder 12 has the unique capability of generally conforming to the contours of the human foot and leg so that it can be comfortably worn inside a boot or shoe.

Bonded to the inner surface 20 of the elastomeric bladder is a lightweight covering member such as a first fabric inner sock 22 of standard construction, which is preferably made from knitted natural or synthetic fibers (FIG. 7). Sock 22 is of a second size smaller than said first size and a second length less than the first length of bladder 12.

The article of the invention also includes a second fabric outer sock 40, the body portion 40a of which is bonded to the outer surface of the body portion 14 of bladder 12 in the manner previously described. Outer sock 40 also includes an upper cuff portion 40b that embodies elastic fibers that impart elasticity to the cuff portion causing it to be continuously urged inwardly toward the covered extremity in the manner indicated by the arrow 42 of FIG. 7. As in the earlier described embodiments outer sock 40 is of a third size larger than the first size of bladder 12 and has a third length greater than the second length of inner sock 20 and also greater than the first length of bladder 12. Also shown in FIG. 1, the cuff portion of outer sock 40 uniquely comprises a first or lower section 44 that is in overlaying engagement with bladder 12 and a second upper section 46 that extends beyond the upper edge 12a of bladder 12.

As before, the entire outer surface of the first sock 22 is securely bonded to bladder 12. However, as best seen in FIG. 7, the cuff, or upper portion 16 of bladder 12, has its outer surface securely bonded to the elastic cuff portion 44 of an outer sock 40. With this construction, elastic cuff 44 uniquely functions to urge the inner surface of the bladder into sealing engagement with the user's leg “L” in the manner illustrated in FIG. 7 (see also FIGS. 1 and 5).

If desired, the portion of the elastic cuff that extends beyond upper edge 12a of the bladder can be folded down in the manner shown in FIGS. 8 and 9. When so folded down, additional forces are exerted on the bladder in the direction of the arrows 47 of FIG. 9 that tend to urge the bladder into sealing engagement with the user's leg “L”. When the sock is in use, these inward forces cause the glaze-like surface 49 formed on the bladder portion 44 to sealably press against the skin of the user forming a substantially watertight seal. As previously mentioned, even when the user's foot and lower leg is submersed in water, this novel seal action will prevent water from passing between bladder portion 44 and the user's skin.

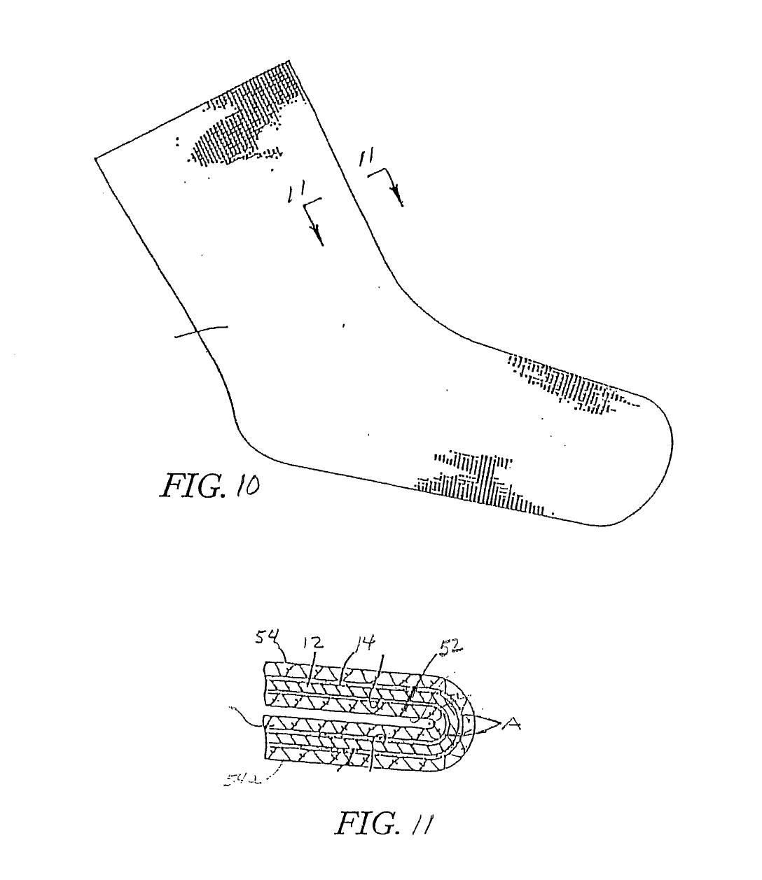

Referring next to FIGS. 10 and 11, an alternative form of the article of apparel of the present invention is there shown. This alternative form of the article of the invention is similar in many respects to the previously described embodiments of the invention and like numerals are used to identify like components. One of the major differences between this latest form of the article of apparel of the invention and those previously described resides in the fact that the extremity-covering portion of the article of apparel is constructed in a special way using a special yarn that includes a stretchable yarn component. Another difference resides in the fact that a specially formulated adhesive is used to bond the fabric components of the article of apparel to the bladder components thereof. A further difference resides in the method by which the precursor made up of the fabric components and a stretchable bladder is heated and compressed. As best seen in FIG. 11, the article of apparel of this latest form of the invention comprises a sock construction that includes a thin, pliant bladder 12 that, save for the adhesive formulation that is deposited on the bladder, is identical in construction to the bladder described in connection with the embodiments shown in FIGS. 1 through 9 of the drawings. More particularly, the bladder of this latest form of the invention is constructed in accordance with the method previously described from a waterproof, breathable material, such as polyurethane sheet that can be of various thicknesses as, for example, between about 1.0 mils and about 3.0 mils.

Bonded to the inner surface of the elastomeric bladder 12 is a lightweight covering member such as a first fabric inner sock 52 that includes a body portion 52a that is uniquely constructed from a specially formulated knitting yarn that includes a multiplicity of elastic fibers that impart elasticity to the body portion of the inner sock. The techniques for weaving the stretch and return body portion 52b are well understood by those skilled in the art and several elastic fibers such as a fiber sold by duPont under the name and style “LYCRA” can be used in conjunction with other fibers to form the body portion. Sock 52 is of a second size smaller than the size of bladder 12.

This latest form of the article of the invention also includes a second fabric outer sock 54, the body portion 54a of which is bonded to the outer surface of the body portion 14 of bladder 12. Body portion 54a, like a body portion 52, is uniquely constructed from a specially formulated knitting yarn that includes a multiplicity of elastic fibers that impart elasticity to the body portion of the outer sock.

Inner sock 52 and outer sock 54 are bonded to bladder 12 by means of a specially formulated, heat activated adhesive “A”. In this regard, in the construction of the non stretch and return body portions of the articles of apparel illustrated in FIGS. 1 through 9 of the drawings as well as in the construction of the articles of apparel described in incorporated by reference U.S. Pat. Nos. 5,655,226 and 5,483,703, the adhesive used to bond the fabric components of the articles of apparel to the membrane component typically comprised a hot melt adhesive in powder form sold by EMS-Chemie (North America) Inc., of Sumpter, S.C. under the name GRILTEX 8 The size of the particles of this powdered adhesive varied widely and included particles of a size 60 to 200 microns in diameter. When the EMS adhesive was used in connection with the manufacture of the improved stretch and return articles of the invention illustrated in FIGS. 10 and 11 in which the fabric components included the Lycra spandex yarn component, it was observed that periodically the fabric components would undesirably separate from the stretchable membrane. The cause of this sporadic non-lamination was not immediately apparent and for some time and resulted in substantial frustration and significant loss of product. After considerable experimentation it was determined that the non-lamination was caused by variation of the particles size of the adhesive from one lot to another. Further experimentation revealed that the non-lamination could be traced to lots of the adhesive that exhibited a high percentage of small particles. Following this determination, a specially formulated adhesive having particle sizes of between 200 and 300 microns was used in the fabrication process.

While the use of the larger particle size adhesive effectively solved the delamination problem, the larger particles undesirably tended to fill the stitch holes in the fabric components which substantially and unacceptably degraded the appearance of the finished article. As will be discussed more fully in the paragraphs which follow, in order to solve this latest problem, the laminating temperature was elevated and the pressure exerted on the laminate during the pressing step was reduced. Quite unexpectedly these changes in the character of the adhesive, in the laminating temperature and in the pressure exerted during the lamination process produced substantially superior bonding and a substantially superior end product.

In the novel article of the present invention, the entire outer surface of the first sock 52 is securely bonded to bladder 12 using the specially formulated powdered adhesive wherein the size of particles is limited to between approximately 200 and 300 microns. Similarly, the second fabric components or sock 54 is securely bonded to bladder 12 using the specially formulated powdered adhesive. The assembly of the fabric and bladder components are accomplished in the manner previously described herein using the assembly mandrel 30. The precursor assembly comprising the bonded together first sock 52, the adhesive coated bladder 12 and the second sock 54 is then heated and compressed to form the finished article. This step is accomplished by placing the mandrel 30, upon which the precursor assembly is mounted, between two platens which can be controllably heated and urged together. More particularly, the platens are preferably electrically heated to a temperature between about 260° F. and about 340° F. and are controllably moved into pressural engagement with the precursor assembly by any type of hydraulically actuated pressure imparting assembly of a character well known to those skilled in the art. During this temperature-pressure step, the heat-activated adhesive is thereby fused making a permanent, water resistant bond of inner sock 52 to one side of the bladder and the outer sock 54 to the other side of the bladder. As previously mentioned, in accordance with this latest method of the invention, the platens are controllably heated to a higher temperature of between about 325° F. and about 400° F. Additionally, the pressure exerted on the platens during the compression step was reduced to a pressure of between about2 p.s.i. and about20 p.s.i..

Following the heating and compression step, the precursor assembly is removed from the press and allowed to cool thoroughly prior to removing the completed waterproof footwear article from the mandrel.

When removed from the mandrel, the footwear article is generally planar in shape. However, upon inserting the foot into the open cuff of the article, the foot-engaging portion of the sock will neatly and smoothly conform to the shape of the wearer's foot.

In carrying out the method of the invention, the previously discussed, specially formulated adhesive is the first uniformly distributed over the membrane material preferably at the rate of about 16.5 grams per square yard and is thermally fused to the membrane by passing a radiant heater over the adhesive-coated membrane. In practice, the radiant heater is controllably passed over the adhesive coated membrane in a manner to elevate the temperature of the adhesive above its melting point, thereby fusing the adhesive to the membrane without melting the membrane. More particularly with the temperature of the heater set at about 764 degrees Fahrenheit, the heater is preferably passed over the assemblage at a rate of travel of about 92 inches per minute. During this step, the face of the radiant heater is preferably positioned about 2¼ inches above the membrane. The membrane with adhesive fused to one side is then turned over with the uncoated side facing up. Again, a coating of the specially formulated powdered adhesive is distributed on the second side of the membrane and is fused to the membrane in the manner just described, thus providing a membrane with adhesive particles fused uniformly to both sides.

Depending upon the end use of the article, the various commercially available adhesives can also be used in the practice of the method of the invention so long as the particles size of the adhesive is controlled to between about 200 and about 300 microns in size.

Following the step of depositing the specially formulated adhesive on the membrane sheets, the bladder 12 is constructed in the manner previously described. More particularly, in accomplishing this step two thicknesses of the adhesive coated membrane sheets are laid together and placed onto the bottom platen of the press. A second sheet of fluorocarbon polymer coated fiberglass material is next placed over the sheet of adhesive coated membrane. The upper platen of the press which is equipped with a die in the desired shape of the sock is then heated and controllably forced against the two thicknesses of adhesive coated membrane which are resting on the lower platen of the press. The lower platen is not heated and remains at room temperature. As before, the welding press is equipped with controls so adjustments may be made to vary temperature, dwell times and the force imposed by the platens one against the other.

As to the method of this latest form of the invention for assembling the precursor assembly, this step is accomplished in the manner previously described herein. More specifically, the first covering member, or inner sock 54, it is placed over a generally foot-shaped, approximately 1/16th inch thick, generally planer mandrel which is of the character previously described. Inner sock 54, which has inner and outer surfaces, is disposed in engagement with the faces of the mandrel. After inner sock 54 has been placed over the mandrel, and smoothed out so that its inner surface is in close engagement with the faces of the mandrel, the bladder 12, which has been coated with particles of the previously discussed, specially formulated hot melt adhesives then carefully placed over the assemblage of inner sock 54 and the mandrel. The bladder is smoothed to be in close engagement with the outer surface of inner sock 54. Outer sock 56 is then carefully placed over both the inner sock 54 and the adhesive coated bladder assemblage on the mandrel.

The precursor assembly comprising first inner sock, the adhesive coated bladder 12 and the outer sock is then placed between heated platens in the manner previously described and heated for about one to two minutes. The heated assemblage is then compressed under reduced pressure in the manner previously described.

Having now described the invention in detail in accordance with the requirements of the patent statutes, those skilled in this art will have no difficulty making changes and modifications in the individual parts or their relative assembly in order to meet specific requirements or conditions. Such changes and modifications may be made without departing from the scope and spirit of the invention, as set forth in the following claims.

I claim:

1. A method of making an article of apparel used to cover a wearer's extremities comprising the steps of:
(a) depositing a heat activated adhesive on the surface of a stretchable, waterproof, breathable membrane to form a coated membrane, said heat activated adhesive comprising a powdered adhesive having particles ranging in size from about 200 to about 300 microns;
(b) forming said coated membrane into a bladder having a perimeter of a first size and having an extremity receiving portion in the general shape of the wearer's extremity to be covered, said bladder having a smooth outer surface and a smooth inner surface generally conformable to the contours of the extremity to be covered;
(c) placing said bladder over a first fabric member constructed from a yarn having a stretchable yarn component, said first fabric member being of a second size smaller than said first size and being in the general shape of the wearer's extremity to form a first assemblage having a third size;
(d) placing a second fabric member constructed from a yarn having a stretchable yarn component over said first assemblage to form a second assemblage, said second fabric member being of a fourth size larger than said third size of said first assemblage; and
(e) simultaneously heating said second assemblage to a temperature of between about 325 and about 400 degrees Fahrenheit and compressing said second assembly at a pressure sufficient to form a composite in which said first and second fabric members are securely bonded to said bladder.

2. A method as defined in claim 1 in which said second assemblage is compressed at a pressure of between about 5 p.s.i. and about 20 p.s.i..

3. A method as defined in claim 1 in which said waterproof, breathable membrane comprises a thin, generally planar, smooth surfaced thin film having a wall thickness of between about 0.001 inch and about 0.0018 inch.

4. A method as defined in claim 1 in which the article of apparel comprises a sock.

5. A method of making an article of apparel used to cover a wearer's extremities comprising the steps of:
(a) depositing a heat activated adhesive on the surface of a stretchable, waterproof, breathable membrane to form a coated membrane, said heat activated adhesive comprising a powdered adhesive having particles ranging in size from about 200 toll about 300 microns;
(b) forming said coated membrane into a bladder having a perimeter of a first size and having an extremity receiving portion in the general shape of the wearer's extremity to be covered, said bladder having a smooth outer surface and a smooth inner surface generally conformable to the contours of the extremity to be covered;
(c) placing said bladder over a first stretch and return fabric member constructed from a knitting yarn having a multiplicity of stretchable yarn components, said first stretch and return fabric member being of a second size smaller than said first size and being in the general shape of the wearer's extremity to form a first assemblage having a third size;
(d) placing a stretch and return second fabric member constructed from a knitting yarn having a multiplicity of stretchable yarn components over said first assemblage to form a second assemblage, said second fabric member being of a fourth size larger than said third size of said first assemblage; and
(e) heating said second assemblage to a temperature of between about 345 and about 400 degrees Fahrenheit to form a heated second assemblage;
(f) compressing said heated second assembly at a pressure of between about 5 p.s.i. and about 20 p.s.i. to form a composite in which said first and second fabric members are securely bonded to said bladder.

6. A method as defined in claim 5 in which said waterproof, breathable membrane comprises a thin, generally planar, smooth surfaced thin film having a wall thickness of about 0.001 inch.

7. A method of making a sock used to cover a wearer's foot comprising the steps of:
(a) depositing a heat activated adhesive on the surface of a stretchable, waterproof, breathable membrane having a thickness of between about 0.001 inch to about 0.0118 inch to form a coated membrane, said heat activated adhesive comprising a powdered adhesive having particles ranging in size from about 200 to about 300 microns;
(b) forming said coated membrane into a bladder having a perimeter of a first size and having an extremity receiving portion in the general shape of the wearer's foot, said bladder having a smooth outer surface and a smooth inner surface generally conformable to the contours of the wearer's foot;
(c) placing said bladder over a first stretch and return fabric member constructed from a knitting yarn having a multiplicity of stretchable yarn components, said first stretch and return fabric member being of a second size smaller than said first size and being in the general shape of the wearer's extremity to form a first assemblage having a third size;
(d) placing a stretch and return second fabric member constructed from a knitting yarn having a multiplicity of stretchable yarn components over said first assemblage to form a second assemblage, said second fabric member being of a fourth size larger than said third size of said first assemblage; and
(e) heating said second assemblage to a temperature of between about 345 and about 400 degrees Fahrenheit to form a heated second assemblage;
(f) compressing said heated second assembly at a pressure of between about 5 p.s.i. and about 20 p.s.i. to form a composite in which said first and second fabric members are securely bonded to said bladder.

8. A method as defined in claim 7 in which said waterproof, breathable membrane comprises a thin, generally planar, smooth surfaced thin film having a wall thickness of about 0.001 inch.
